(19) United States
(12) Patent Application Publication
(10) Pub. No.: US 2026/0217307 A1
(43) Pub. Date: Jul. 30, 2026

(54) SNOWMOBILE SKI ASSEMBLY AND METHOD FOR ADJUSTING A SKI RUNNER OF A SKI THEREOF

(71) Applicant: BRP MEGATECH INDUSTRIES INC., Valcourt (CA)

(72) Inventors: Samuel GENEREUX, Saint-Tite (CA); Alec FOISY, Shawinigan (CA)

(21) Appl. No.: 19/454,980

(22) Filed: Jan. 21, 2026

Related U.S. Application Data
(60) Provisional application No. 63/751,511, filed on Jan. 30, 2025.

(51) Int. Cl. B62D 6/00; B62M 27/02

(52) U.S. Cl. CPC B62D 6/00; B62M 27/02; B62M 2027/025

(57) ABSTRACT

A snowmobile ski assembly and a method for adjusting a ski runner thereof. The method includes sensing, by a steering angle sensor, a steering angle and receiving, by the controller, a steering angle signal. The steering angle signal is indicative of the steering angle. The method continues with the controller generating an adjustment signal based on the steering angle signal. The method proceeds with moving the ski runner relative to the ski to adjust a distance by which the ski runner extends below the ski, the ski runner being moved by an actuator operatively connected to the ski runner, the actuator being actuated in response to the adjustment signal.

### CROSS-REFERENCE

The present application claims priority to U.S. Provisional Application No. 63/751,511, filed on Jan. 30, 2025, which is incorporated herein by reference in its entirety.

### FIELD OF TECHNOLOGY

The present technology relates to a snowmobile ski assembly, and to a method for adjusting a ski runner of a ski of said snowmobile ski assembly.

### BACKGROUND

Snowmobile skis are equipped with ski runners which protrude from the bottom of the skis and influence how the snowmobile responds to a steering input and navigates various terrains. The distance by which the ski runner extends below the ski is particularly important, since a small change to this distance can have a significant effect. Insufficient extension can result in sluggish responsiveness and poor tracking while turning. Excessive extension can lead to overly aggressive steering and darting, where the skis of the snowmobile erratically jump between grooves on compacted trails. Both too much and too little extension may lead to reduced driveability of the snowmobile, fatiguing the driver, over varying snow conditions.

Existing mechanism allow for manual adjustment of the extension of the ski runner. However, these manual systems require the driver to stop, readjust, and test multiple times to achieve a desired setting. Additionally, as each ski assembly is independently adjusted, synchronizing the extensions between the two ski runners may be challenging and inconsistent. Further, during a single drive, the driver may experience different snow conditions and handling operations. As such, with manual ski runner adjustments, the driver may have to compromise on the ski runner extension, leading to reduced performance.

In view of the foregoing, there is a need for a snowmobile ski assembly for a snowmobile that addresses at least some of these drawbacks.

### SUMMARY

It is an object of the present technology to ameliorate at least some of the inconveniences present in the prior art.

According to an aspect of the present technology, there is provided a method for adjusting a ski runner of a ski of a snowmobile. The method includes: sensing, by a steering angle sensor, a steering angle; receiving, by a controller, a steering angle signal from the steering angle sensor, the steering angle signal being indicative of the sensed steering angle; generating, by the controller, an adjustment signal based on the steering angle signal; and moving the ski runner relative to the ski to adjust a distance by which the ski runner extends below the ski, the ski runner being moved by an actuator operatively connected to the ski runner, the actuator being actuated in response to the adjustment signal.

In some embodiments, the steering angle signal is a first steering angle signal indicative of a first sensed steering angle; and the method further includes: determining, by the controller, if the first sensed steering angle is inside a predetermined angle range; in response to the first sensed steering angle being inside the predetermined angle range: initiating, by the controller, a timer for timing a predetermined time; sensing, by the steering angle sensor, a second steering angle; receiving, by the controller, a second steering angle signal from the steering angle sensor, the second steering angle signal being indicative of the second sensed steering angle; determining, by the controller, if the second sense steering angle is inside the predetermined angle range; in response to the second steering angle signal being inside the predetermined angle range, determining, by the controller, if the predetermined time has elapsed; and in response to the predetermined time having elapsed, moving the ski runner relative to the ski to adjust the distance by which the ski runner extends below the ski using the actuator, the adjustment signal being based on the second steering angle signal

In some embodiments, in response to the at least one of the first steering angle and the second steering angle being inside the predetermined angle range, resetting the timer.

In some embodiments, the predetermined angle range is between approximately −7.5° and 7.5°.

In some embodiments, the predetermined time is approximately 8 seconds.

In some embodiments, generating the adjustment signal by the controller includes referencing a predetermined look-up table providing distance values for given steering angle values.

In some embodiments, the method further includes sensing, by a speed sensor, a speed of the snowmobile; and receiving, by the controller, a speed signal from the speed sensor, the speed signal being indicative of the sensed speed of the snowmobile.

In some embodiments, generating the adjustment signal by the controller includes referencing stored data within a memory storage of the snowmobile, the store data providing distance values for given steering angle values and speed values.

In some embodiments, the method further includes sensing, by a yaw sensor, a yaw of the snowmobile; receiving, by the controller, a yaw signal indicative of the sensed yaw of the snowmobile; and wherein the adjustment signal is further based on the yaw signal.

In some embodiments, the method further includes sensing, by a lateral acceleration sensor, the lateral acceleration of the snowmobile; receiving, by the controller, a lateral acceleration signal indicative of the sensed lateral acceleration of the snowmobile; and wherein the adjustment signal is further based on the lateral acceleration signal.

In some embodiments, the lateral acceleration sensor is an accelerometer.

In some embodiments, receiving, by the controller, a hard surface signal; and in response to receiving the hard surface signal, retracting the ski runner with the actuator.

In some embodiments, the method further includes receiving a user input generating the hard surface signal.

In some embodiments, the method further includes receiving, by the controller, an activation signal; and performing the method in response to receiving the activation signal.

In some embodiments, the method further includes selecting a ski runner distance; receiving, by the controller, a ski runner distance signal indicative of the selected ski runner distance; and in response to receiving the ski runner distance signal, moving the ski runner relative to the ski to adjust the distance by which the ski runner extends below the ski using the actuator, the adjustment signal being based on the ski runner distance signal.

According to another aspect of the present technology, a snowmobile ski assembly is provided. The snowmobile ski assembly includes a ski defining a slot; a ski runner disposed in the slot, the ski runner being moveable in the slot relative to the ski; and a runner adjustment assembly connected to the ski runner, the runner adjustment assembly having a motor operatively connected to the ski runner moving the ski runner relative to the ski, the ski runner remaining substantially rotationally fixed relative to the ski during movement of the ski runner.

In some embodiments, a controller operatively connected to the motor of the runner adjustment assembly, the controller being configured to: receive a steering angle signal indicative of a steering angle; and send an adjustment signal to the motor to move the ski runner relative to the ski to adjust a distance by which the ski runner extends below the ski, the adjustment signal being based on the steering angle signal.

In some embodiments, the controller is further configured to receive a speed signal indicative of a speed of the snowmobile; and the adjustment signal is further based on the speed signal.

In some embodiments, the controller is further configured to: receive a user input; and send an adjustment signal to the motor to move the ski runner relative to the ski to adjust a distance by which the ski runner extends below the ski, the adjustment signal being based on the user input.

In some embodiments, the runner adjustment assembly is a linear actuator including the motor.

Embodiments of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

For purposes of this application, terms related to spatial orientation such as forwardly, rearward, upwardly, downwardly, left, and right, are as they would normally be understood by a driver of the snowmobile sitting thereon in a normal driving position. Terms related to spatial orientation when describing or referring to components or sub-assemblies of the vehicle, separately from the snowmobile should be understood as they would be understood when these components or sub-assemblies are mounted to the snowmobile, unless specified otherwise in this application.

In the context of the present application, unless expressly provided otherwise, the words “first”, “second”, “third”, etc. have been used as adjectives only for the purpose of allowing for distinction between the nouns that they modify, and not for the purpose of describing any particular relationship between those nouns.

It must be noted that, as used in this specification and the appended claims, the singular form “a”, “an”, and “the” include plural referents unless the context clearly dictates otherwise.

As used herein, the term “and/or” is to be taken as specific disclosure of each of the two specified features or components with or without the other. For example, “A and/or B” is to be taken as specific disclosure of each of (i) A, (ii) B, and (iii) A and B, just as if each is set out individually herein.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a left side elevation view of a snowmobile;

FIG. 2 is a perspective view taken from a front, right side of a left ski assembly of the snowmobile of FIG. 1;

FIG. 3 is a perspective view taken from a front, right side of a ski of the ski assembly of FIG. 2;

FIG. 4 is a perspective view taken from a rear, right side of the ski of FIG. 3;

FIG. 5 is a right side elevation view of a ski runner of the ski assembly of FIG. 2;

FIG. 6 is a front elevation view of the ski runner of FIG. 5;

FIG. 7 is a perspective view taken from a front, right side of the ski runner of FIG. 5;

FIG. 8 is a right side elevation view of the ski assembly of FIG. 2 with the ski runner in a raised position;

FIG. 9 is a cross-sectional view of the ski assembly of FIG. 2 taken through line 9-9 of the ski assembly with the ski runner in the raised position of FIG. 8;

FIG. 10 is a cross-sectional view of the ski assembly of FIG. 2 taken through line 10-10 right side elevation view of the ski assembly of FIG. 2 with a rear of the ski pivoted upward;

FIG. 11 is a right side elevation view of the ski assembly positioned as in FIG. 10 with the ski removed;

FIG. 12 is a front elevation view of a runner adjustment assembly of the ski assembly of FIG. 2;

FIG. 13 is a cross-sectional view of the runner adjustment assembly of FIG. 12 taken through line 13-13 of FIG. 12 with the adjustment assembly raised;

FIG. 14 is a cross-sectional view of the runner adjustment assembly of FIG. 12 taken through line 13-13 of FIG. 12 with the adjustment assembly lowered;

FIG. 15 is an exploded view of the runner adjustment assembly of FIG. 12;

FIG. 16 is a schematic of inputs and controllers of the snowmobile for controlling an actuator of the ski assembly; and

FIG. 17 is a flow diagram depicting a method for adjusting a ski runner of a ski of a snowmobile.

### DETAILED DESCRIPTION

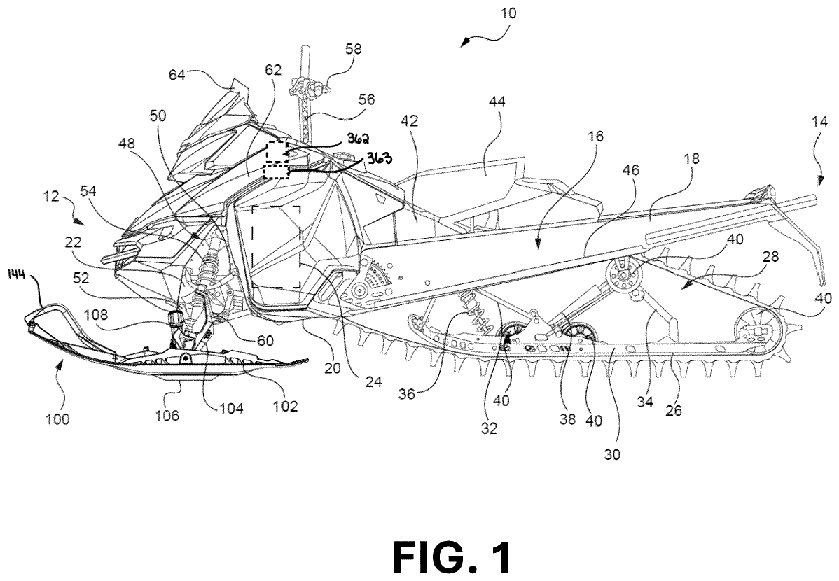

With reference to FIG. 1, a snowmobile 10 will be described. Although a snowmobile 10 is presented herein, it is contemplated that aspects of the present technology could be applied to other types of vehicles with skis for operation on snow.

The snowmobile has a front end and a rear end, which are defined consistently with the forward travel direction of the snowmobile 10. The snowmobile 10 includes a frame 16. The frame 16 includes a tunnel 18, a motor cradle portion 20, and a front suspension assembly portion 22. A motor 24, which is schematically illustrated, is supported by the motor cradle portion 20. In the present embodiment, the motor 24 is an internal combustion engine 24, referred to hereinafter as the engine 24. It is contemplated that, in alternative embodiments, the motor 24 may be an electric motor.

An endless drive track 26 is disposed under the tunnel 18. The endless drive track 26 is operatively connected to the engine 24 through a continuously variable transmission (CVT, not shown). The endless drive track 26 is suspended for movement relative to the frame 16, by a rear suspension assembly 28. The rear suspension assembly 28 includes a pair of spaced apart slide rails 30, rear suspension arms 32, 34 and shock absorbers 36, 38. The slide rails 30 engage the inner side of the endless drive track 26. The rear suspension arms 32, 34 and the shock absorbers 36, 38 pivotally connect the tunnel 18 to the slide rails 30. The endless drive track 26 is driven to run about the rear suspension assembly 28 for propulsion of the snowmobile 10. A plurality of rollers 40 define the path over which the endless drive track 26 travels.

A fuel tank 42 is supported on top of the tunnel 18. A seat 44 is disposed on the fuel tank 42 and is adapted to support a driver. Two footrests 46 (only one of which is shown) are positioned on opposite sides of the tunnel 18, below the seat 44, to support the driver's feet. The footrests 46 are integrally formed with the tunnel 18.

Left and right ski assemblies 100 are positioned at a front of the snowmobile 10 (only the left ski assembly 100 being shown in FIG. 1). However, in alternative embodiments, the snowmobile 10 may have only one ski assembly 100. Each ski assembly 100 includes a ski 102, a corresponding ski leg 104, and other components described in detail below. Each ski assembly 100 is attached to the front suspension assembly portion 22 of the frame 16 via a front suspension assembly 48. Each front suspension assembly 48 includes an upper A-arm 50, a lower A-arm 52, and a shock absorber 54. Each ski leg 104 is pivotally connected to a corresponding upper and lower A-arm 50, 52. A corresponding shock absorber 54 is connected between the lower A-arm 52 and the front suspension assembly portion 22 of the frame 16. It is contemplated that other types of front suspension assemblies could be used.

A steering assembly including a steering column 56 and handlebar 58 is supported by the frame 16. The steering column 56 is attached at its upper end to the handlebar 58, which is positioned forward of the seat 44. The steering column 56 is operatively connected to the ski legs 104 by steering rods 60 to steer the skis 102, and thereby the snowmobile 10, when the handlebar 58 is turned.

Fairings 62 enclose the engine 24 and the CVT, thereby providing an external shell that protects the engine 24 and CVT. The fairings 62 include a hood and one or more side panels that can be opened to allow access to the engine 24 and the CVT when this is required, for inspection or maintenance of the engine 24 and/or the CVT for example. A windshield 64 is connected to the fairings 62 forward of the handlebar 58. It is contemplated that the windshield 64 could be attached directly to the handlebar 58.

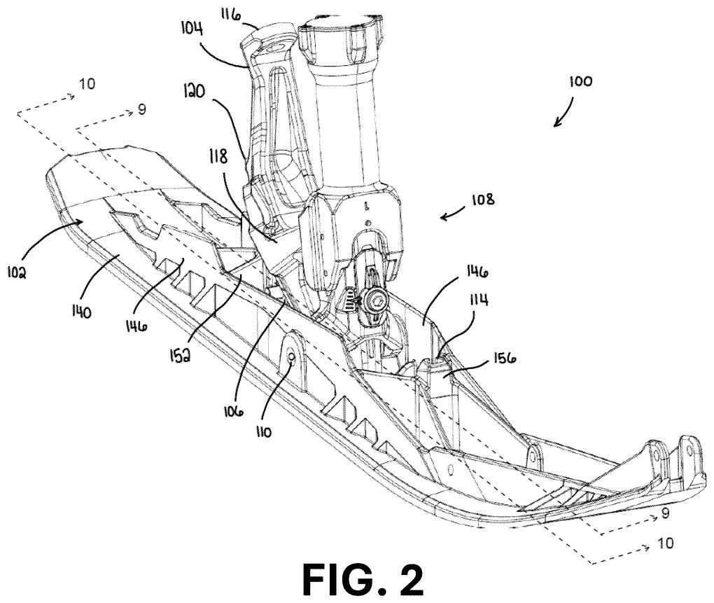

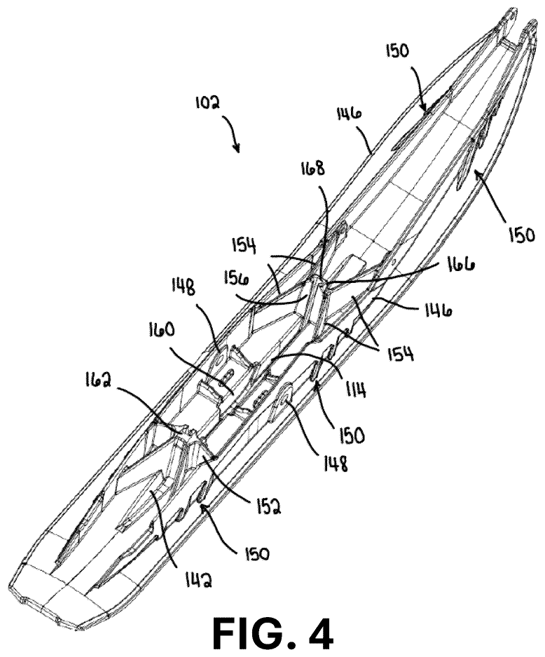

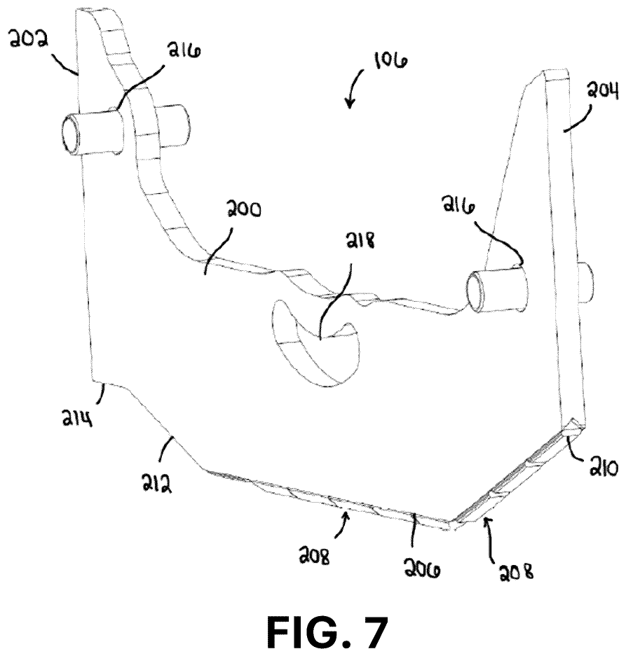

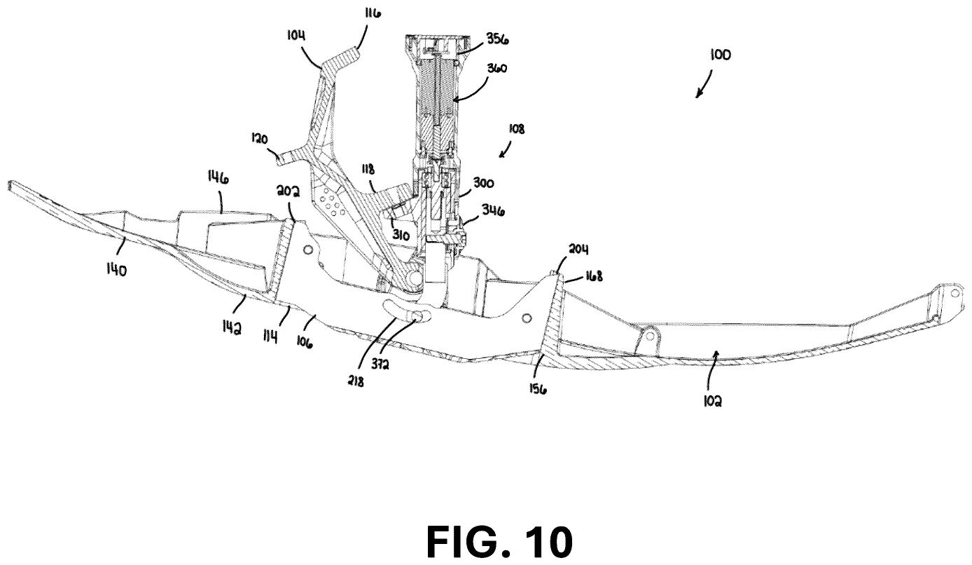

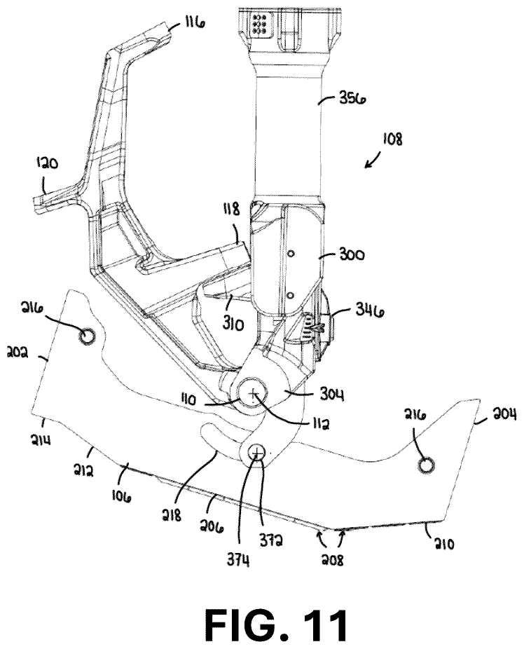

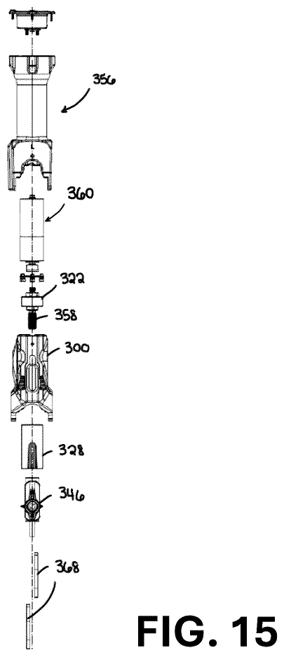

With reference to FIGS. 2 to 15, the ski assemblies 100 will now be described in detail. In the present embodiment, the left and right ski assemblies 100 are similar (mirror images of one another), and thus, for clarity only the left ski assembly 100 will be described, and reference hereinafter will broadly be made to the ski assembly 100. It is contemplated that, in alternative embodiments, the left and right ski assemblies 100 may differ from one another.

The ski assembly 100 includes the ski 102, the ski leg 104, a ski runner 106, and a runner adjustment assembly 108. In alternative embodiments, the ski leg 104 may be omitted from the ski assembly 100, and instead be provided on the snowmobile 10.

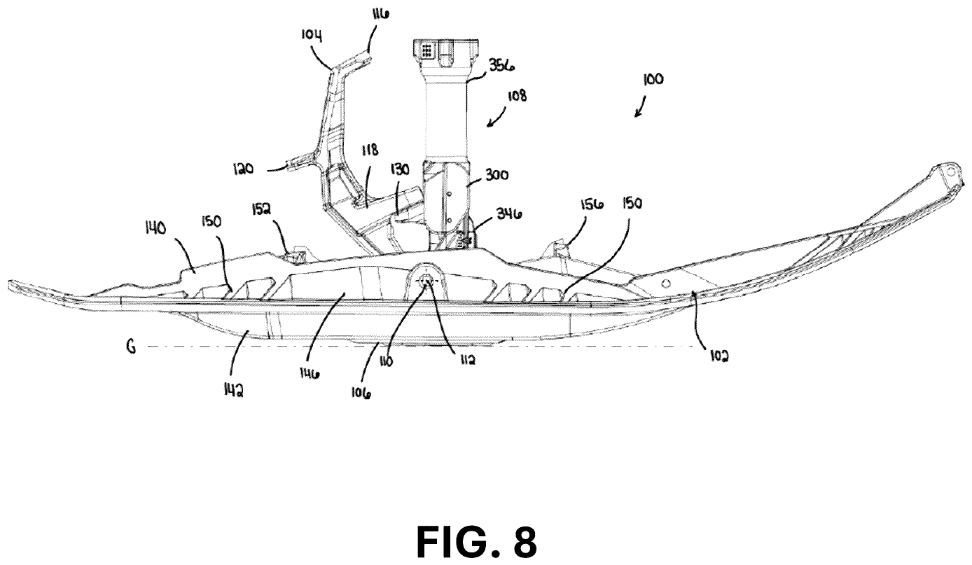

As can be see in FIG. 2, the ski 102 is pivotally connected to a bottom of the ski leg 104 by a fastener 110, such as a bolt 110 or any other suitable fastener 110. The bolt 110 defines a laterally extending ski pivot axis 112 (FIG. 8) about which the ski 102 pivots relative to the ski leg 104. The runner adjustment assembly 108 is connected to the bolt 110 at the ski pivot axis 112 and to the ski leg 104, allowing the ski 102 to pivot about the ski pivot axis 112 relative to the runner adjustment assembly 108.

The runner adjustment assembly 108 is positioned in front of the ski leg 104, closer to a front of the ski 102. The ski runner 106 is inserted into a slot 114 defined in the ski 102. The slot 114 stabilizes the ski runner 106 laterally, preventing the ski runner 106 from rotating relative to the ski 102.

The runner adjustment assembly 108 is also connected to the ski runner 106 and is used to move the ski runner 106 within the slot 114. This movement changes the distance by which the ski runner 106 extends below the ski 102, as will be described in detail below. By adjusting the extension of the ski runner 106, the ski assembly 100 can be optimized for different riding conditions.

The runner adjustment assembly 108 provides the only vertical load-bearing connection between the ski runner 106 and the ski leg 104, since the ski runner 106 is not directly connected to the ski 102. As such, the ski 102 bears a vertical load only when its bottom surface is in contact with a surface on which the snowmobile 10 rides. Vertical forces applied upward to the ski runner 106 are transferred to the runner adjustment assembly 108 and not to the ski 102. As depicted in FIG. 8, when the snowmobile 10 is flat, on level ground G, such as when riding on an icy level surface, the ski assembly 100 is supported solely by the ski runner 106 and the bottom of the ski 102 remains spaced above the ground G. Under these conditions, the weight of the snowmobile 10 results in a force passing through the ski leg 104, the runner adjustment assembly 108, and the ski runner 106 to the ground G, without passing through the ski 102.

With reference to FIG. 8, the ski leg 104 has an upper front tab 116, a lower front tab 118, and a rear tab 120. A ball joint stud (not depicted) is inserted through and connected to the upper front tab 116 by a nut (not depicted), thereby connecting the ski leg 104 to a ball joint (not depicted) at an end of the upper A-arm 50. A ball joint stud (not depicted) is inserted through and connected to the lower front tab 118 by a nut (not depicted), thereby connecting the ski leg 104 to a ball joint 128 (not shown) at the end of the lower A-arm 52. A ball joint stud (not depicted) is inserted through and connected to the rear tab 120 by a nut (not depicted), which links the ski leg 104 to a ball joint (not depicted) at the end of the steering rod 60. When the driver of the snowmobile 10 turns the handlebar 50, the steering rod 60 pushes or pulls on the rear tab 120, depending on the steering direction. This causes the ski leg 104 to pivot about a ski leg pivot axis 134, which passes through the centers of the ball joints inserted within the upper front tab 116 and the lower front tab 118.

With reference to FIGS. 1, 3, 4, and 8, the ski 102 includes a ski body 140, a keel 142 (depicted in FIG. 8) disposed on the bottom of the ski body 140, and a handle 144 (depicted in FIG. 1) connected to the upturned front portion of the ski body 140. In the present embodiment, the ski body 140 and the keel 142 are made of ultra-high molecular weight (UHMW) polyethylene. It is contemplated that the ski body 140 and the keel 142 could be made of any other suitable material in other embodiments.

As mentioned above, the front portion of the ski body 140 curves upwards. The middle and rear portions of the ski body 140, as seen from a side of the ski body 140, are generally flat except for a portion adjacent to the rear end that is angled upwards. As seen from above, the front and rear of the ski body 140 are tapered and the sides of the middle portion are parallel. It is contemplated that the ski body 140 could have a general shape other than as shown in the illustrated implementation. For example, the ski body 140 could have a sidecut or a flat rear end.

The ski body 140 includes left and right longitudinally extending walls 146 that extend upwards from an upper surface of the ski body 140. The walls 146 are positioned laterally inwards of the lateral sides of the ski body 140. It is contemplated that the walls 146 may be disposed along the lateral sides of the ski body 140 or may extend more or less in the longitudinal direction than shown in the illustrated embodiment. The handle 144 is connected between the walls 146. Apertures 148 are defined in the walls 146 to receive the bolt 110, which fastens the ski 102 to the ski leg 104. In the present embodiment, the portions of the walls 146 surrounding the apertures 148 are thicker than other portions of the walls 146 to reinforce these portions of the walls 146. Ribs 150 extend laterally outwards from the walls 146, providing structural reinforcement to the walls 146. It is contemplated that, in alternative embodiments, the ribs 150 may extend laterally inwards from the walls 145. It is further contemplated that the ribs 150 may be omitted.

The ski body 140 has a wall 152 extending laterally between the walls 146. The ski body 140 also has four walls 154 extending angularly inward from the walls 146 to a laterally extending wall 156.

The slot 114 is defined by and extends through the ski body 140 and the keel 142. The slot 114 is disposed along a longitudinal centerline of the ski 102 and extends between the walls 146. It is contemplated that the slot 114 may be positioned off center, and thus not disposed along the longitudinal centerline of the ski 102, in other embodiments. In alternative embodiments, the slot 114 may be defined in the keel 142 and the ski body 140, but open only at the bottom of the keel 142, instead of extending through the keel 142 and the ski body 140. In this instance, an aperture may be provided to allow the runner adjustment assembly 108 to be connected to the ski runner 106.

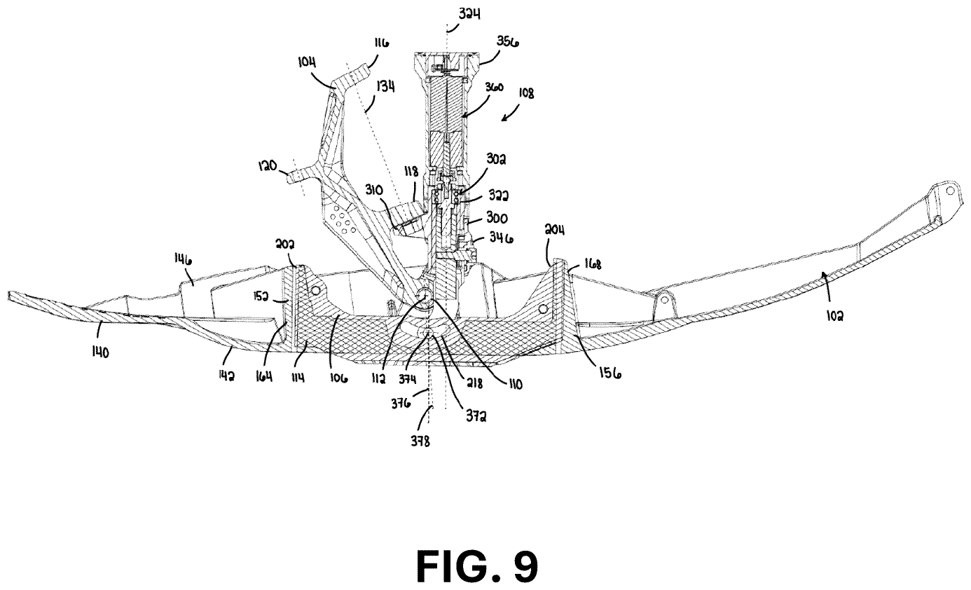

A longitudinal center portion of the slot 114 is wider than the adjacent portions of the slot 114 to accommodate the connection between the ski runner 106 and the runner adjustment assembly 108. The rear end 162 of the slot 114 is defined in the wall 152, defining a rear wall 164. The front end 166 of the slot 114 is defined in the wall 156, defining a front wall 168. As depicted in FIG. 9, the rear and front walls 164, 168 are parallel to each other. In the present embodiment, the rear and front walls 164, 168 are flat. However, in other embodiments, the rear and front walls 164, 168 may not be flat, but may still provide parallel surfaces along which the ski runner 106 can move. For example, the walls 164, 168 may define a series of bumps having the same dimensions.

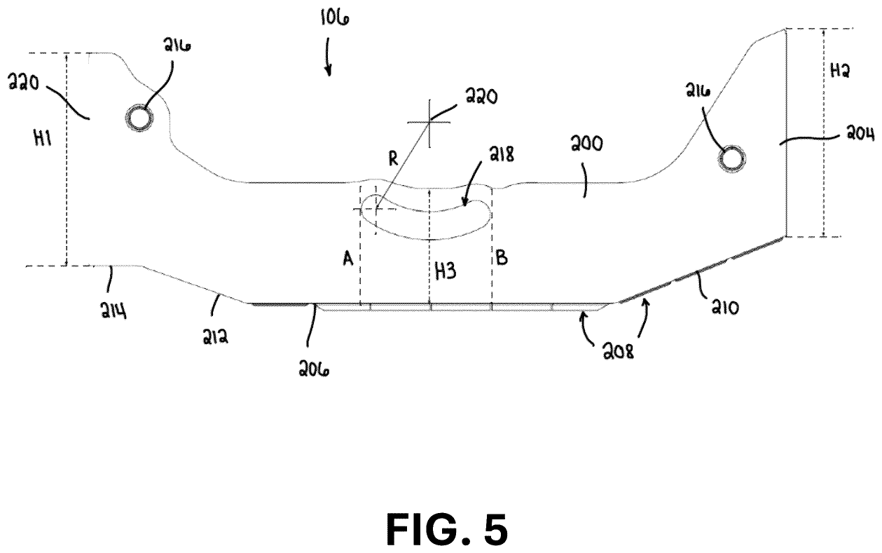

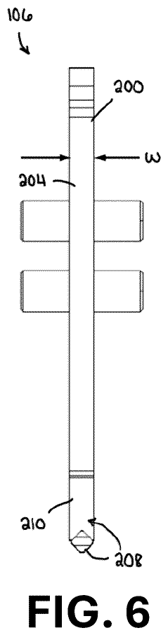

With reference to FIGS. 5 to 7, the ski runner 106 will now be described in detail. The ski runner 106 has a ski runner body 200 cut, by stamping for example, from a metal plate. As a result, the ski runner body 200 is flat and has a uniform width W (depicted in FIG. 6). It is noted that the surface of the ski runner body 200 could be engraved or embossed, to write the manufacturer's name for example, in which case the surface would nonetheless be considered as having a generally uniform width W. It is contemplated that the ski runner body 200 could be made from other materials and by other manufacturing techniques. For example, the ski runner body 200 could be machined, laser cut or cast or by a combination of such techniques.

The ski runner body 200 has a rear flat wall 202 and a front flat wall 204. The walls 202, 204 are parallel to each other. As can be seen in FIG. 9, when the ski runner 106 is inserted in the slot 114, the walls 202, 204 are parallel to the walls 164, 168 of the ski 102 and abut the walls 164, 168 respectively. When the ski runner 106 is adjusted in the slot 114, the wall 202 of the ski runner body 200 moves along the wall 164 and the wall 204 of the ski runner body 200 moves along the wall 168.

The ski runner body 200 has a lower edge referred to herein as the ground engaging edge 206. The ground engaging edge 206 is straight and perpendicular to the walls 202, 204. It is contemplated that the ground engaging edge 206 may not be straight in some embodiments. For example, the ground engaging edge 206 could be convex. It is also contemplated that, in some embodiments, the ground engaging edge 206 could not be perpendicular to the walls 202, 204. The ground engaging edge 206 forms a channel configured to receive wearbars 208. The wearbars 208 are brazed to the ski runner body 200. The wearbars 208, as their name suggest, are intended to contact the ground and wear instead of the ski runner body 200. The wearbars 208 are sometimes referred to as carbides in reference to the material from which they are usually made. It is contemplated that the wearbars 208 could be connected to the ski runner body 200 by other means. It is also contemplated that the wearbars 208 could be omitted. It is noted that, when the ski assembly 100 operates on a hard surface such as asphalt when the snowmobile 10 has to cross a paved road, because of the wearbars 208, the ground engaging edge 206 does not actually engage the ground, but it is nonetheless referred to as a ground engaging edge 206 for purposes of the present application.

A front angled edge 210 connects the front end of the ground engaging edge 206 to the bottom of the front wall 204. The front angled edge 210 also forms a channel inside which wearbars 208 are brazed. A rear angled edge 212 connects the rear end of the ground engaging edge 206 to the front end of a horizontal edge 214, and the rear end of the horizontal edge 214 is connected to the bottom of the rear wall 202. As best seen in FIG. 5, the top side of the ski runner body 200 is recessed, which makes the ski runner body 200 generally U-shaped.

The ski runner body 200 has two apertures 216 defined therein. These are used to hold the ski runner body 200 in place during the manufacturing process. It is contemplated that the apertures 216 could be omitted.

The ski runner body 200 defines an arcuate slot 218 in a central portion thereof. The arcuate slot 218 is closer to the rear wall 202 than to the front wall 204. The arcuate slot 218 has a center of curvature 220. A radius of curvature R of the arcuate slot 218 corresponds to a distance between the pivot axis 112 of the ski 102 and the center of the arcuate slot 218 at one of the positions of the ski runner 106 in the slot 114. The arc length of the arcuate slot 218 is selected based on a desired amount of rotation of the ski 102 about the pivot axis 112. In the present embodiment, the arc length of the arcuate slot 218 is selected to provide 20 degrees of rotation of the ski 102 about the pivot axis 112 in one direction and 40 degrees in the other direction. It is contemplated that the arc length of the arcuate slot 218 could be longer or shorter. As best seen in FIG. 5, the height H1 of the rear wall 202 and the height H2 of the front wall 204 are greater than a height H3 of the ski runner body 200 measured between the ground engaging edge 206 and the top side of the ski runner body 200 at all locations aligned with the arcuate slot 218 (i.e. between the lines A and B). As can also be seen in FIG. 5, the vertical distance between the top of the rear wall 202 and the ground engaging edge 206 and the vertical distance between the top of the front wall 204 and the ground engaging edge 206 are greater than the vertical distance between the highest point of the arcuate slot 218 and the ground engaging edge 206. The vertical distance between the bottom of the rear wall 202 and the ground engaging edge 206 is smaller than the vertical distance between the lowest point of the arcuate slot 218 and the ground engaging edge 206.

With reference to FIGS. 9 to 15, the runner adjustment assembly 108 will now be described in further detail. The runner adjustment assembly 108 includes a housing 300 inside which an adjustment mechanism 302 is housed in part. As described in further detail below, actuation of the adjustment mechanism 302 causes the ski runner 106 to move up or down within the slot 114, thereby increasing or decreasing the distance by which the ski runner 106 extends below the keel 142 of the ski 102.

The housing 300 has a pair of spaced apart tabs 304. The tabs 304 define apertures 306 inside which bushings (not depicted) are inserted. It is contemplated that, in other embodiments, the bushings may be omitted. The bolt 110 is fastened to an axle (not depicted) received in the bushings, thereby connecting the housing 300 to the ski leg 104. The ski leg 104 is received between the tabs 304. The housing 300 includes a tab 310 defining an aperture 312. In the present embodiment, the aperture 312 is frustoconical in shape and receives a rubber grommet. The nut used to connect the ski leg 104 to the ball joint at the end of the lower A-arm 52 is received in the grommet. As a result, the runner adjustment assembly 108 is prevented from pivoting about the pivot axis 112 relative to the ski leg 104. The housing 300 further defines a slot (not separately numbered) in a front thereof, which is described in further detail below.

The adjustment mechanism 302 has two main parts: a shaft 318 having external threads and a shaft 320 having internal threads. The threaded portion of the shaft 318 is received in the threaded portion of the shaft 320. As the shaft 318 rotates, the shaft 320 slides in and out of the housing 300. It is contemplated that the shaft 318 could have the internal thread and that the shaft 320 could have the external thread. Other types of adjustment mechanisms are contemplated. For example, the shafts 318, 320 could be replaced by a rack and pinion assembly.

The lower portion of the shaft 318 is received in the housing 300 and the top portion of the shaft 318 protrudes from the top of the housing 300. The shaft 318 is received in a ball bearing 322 that is press-fit in a top of the housing 300. As such, the shaft 318 can rotate about a rotation axis 324 without translating along the rotation axis 324. The top of the ball bearing 322 abuts an inner flange 326 defined by the housing 300. The bottom of the ball bearing 322 abuts the top of a sleeve 328 inserted in the housing 300. The bottom of the sleeve 328 abuts a C-clip 330 clipped in the housing 300. The sleeve 328 also defines a slot (not separately numbered) in alignment with the slot of the housing 300.The shaft 318 has a shoulder 334 that abuts the bottom of the ball bearing 322. The portion of the shaft 318 below the shoulder 334 has an external thread thereon.

The shaft 320 is received in the sleeve 328 inside the housing 300 and protrudes from a bottom of the housing 300. The shaft 320 has a bore 336 defined in a top thereof. The bore 336 has an internal thread. The lower threaded portion of the shaft 318 is received in and engages the thread in the bore 336. Grease may be provided in the interface between the shafts 318, 320. An aperture 340 extends from an outer surface of the shaft 320 to permit drainage of any water which enters the bore 336. The aperture 340 opens in a front of the shaft 320 such that water draining from the bore 336 then drains out of the sleeve 328 and the housing 330 via the slot of the sleeve 328.

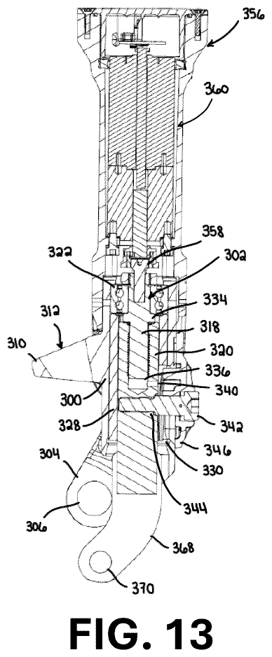

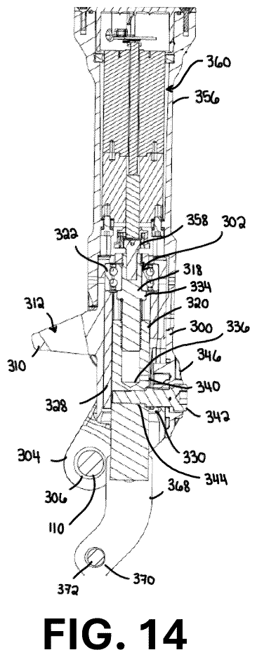

A screw 342 is inserted through the slots of the housing 300 and the sleeve 328, and into a counterbored aperture 344 in the shaft 320. As can be seen in FIGS. 13 and 14, the aperture 344 is perpendicular to the rotation axis 324 and is disposed below the aperture 336. Turning the shaft 318 causes the shaft 320 to move along the rotation axis 324. The screw 342 abuts the sides of the slot 316, thereby preventing the shaft 320 from rotating about the axis of rotation within the shaft 318. The screw 342 also prevent the shaft 320 from moving too far down along the rotation axis 324 by coming into contact with the bottom portion of the slot of the housing 300, thereby stopping the shaft 320 before the threads of the shafts 318, 320 disengage from each other. The upward movement of the shaft 320 is stopped when the top end of the shaft 320 comes into contact with the shoulder 334 of the shaft 318.

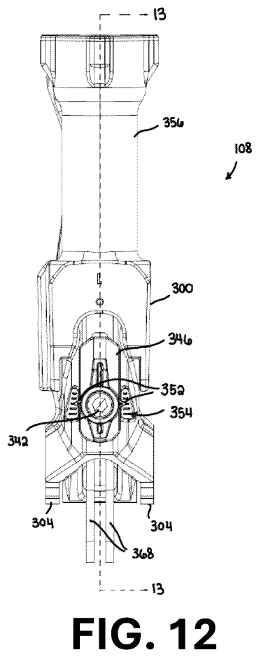

The screw 342 is also inserted through a cover 346 disposed outside the housing 300 so as to cover the slot in the housing to reduce the entry of snow and water into the housing 300 via the slot of the housing 300. The cover 346 moves along the outer surface of the housing 300 with the shaft 320 as the shaft 320 is moved along the rotation axis 324. For this reason, the cover 346 is also used as a position indicator. As best seen in FIG. 12, the cover 346 is provided with triangular projections 352 that provide an indication of the position of the shaft 320, and therefore of the ski runner 106, along markings 354 formed on the outer front surface of the housing 300. To ensure that the screw 342 is not screwed too far into the aperture 344 of the shaft 320, which would squeeze the cover 346 between the screw head of the screw 342 and the outer surface of the housing 300, thereby hindering movement of the shaft 320, the screw 342 has a shoulder that abut the bottom of the counterbore of the aperture 344 once it has been sufficiently screwed in the aperture 344.

The runner adjustment assembly 108 has an actuator 356 having a motor 360 operatively connected to the adjustment mechanism 302. Specifically, the motor 360 is operatively connected to the shaft 318 via a screw 358 fixed to the shaft 318. When the motor 360 rotates the screw 358, the shaft 318 rotates about the rotation axis 324, which in turn drives linear movement of the shaft 320 along the rotation axis 324, described in detail below.

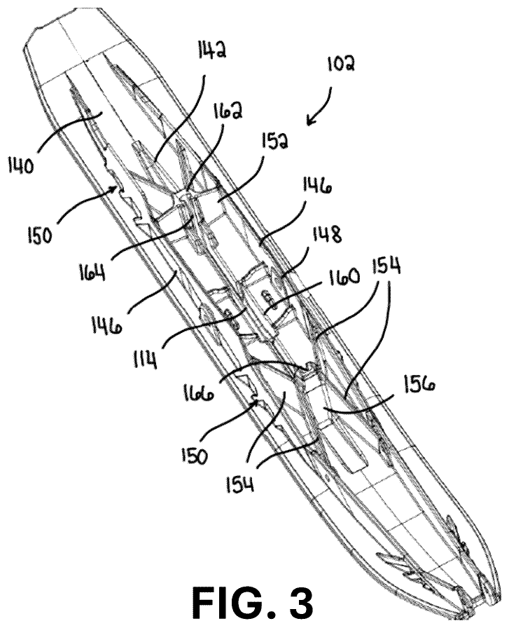

To connect the shaft 320 to the ski runner 106, a pair of bent arms 368 are connected to the lower portion of the shaft 320. In some embodiments, the arms 368 and the shaft 320 may be integrally formed. Each arm has an aperture 370. The ski runner 106 is positioned between the arms 368, with the arcuate slot 218 aligned with the apertures 370. A connector, such as pin 372, is inserted through the apertures 370 of the arms 368 and the arcuate slot 218, thereby securing the ski runner 106 to the runner adjustment assembly 108. The pin 372 defines a laterally extending runner connection axis 374. As depicted in FIG. 9, the runner connection axis 374 is disposed vertically below the ski pivot axis 112. The arms 368 and the pin 372 are received in the wider longitudinal central portion 160 of the slot 114 of the ski body 140 (as seen in FIG. 3). The sides of the wider longitudinal central portion 160 of the slot 114 limit the lateral movement of the pin 372. When the ski 102 pivots about the ski pivot axis 112, the pin 372 moves within the arcuate slot 218 of the ski runner 106. It is contemplated that, in alternative embodiments, the arms 368 could be provided with arcuate slots 218 and the ski runner 106 may define an aperture to receive the pin 372.

The pin 372 serves as the only connection between the ski runner 106 and the rest of the ski assembly 100, ensuring the ski runner 106 is held in place with respect to the ski 102 by the adjustment mechanism 302 and the ski leg 104. Forces applied to the ski runner 106 are transferred through this connection to the adjustment mechanism 302 via the pin 372, then from the adjustment mechanism 302 to the housing 300 by the connection provided therebetween by the bearing 322, and then from the housing 300 to the ski leg 104 by the connection provided therebetween by the bolt 110 and the axle (not depicted). The bolt 110 is positioned vertically between the pin 372 and the bearing 322 (as seen in FIG. 9).

A controller 362 (schematically shown in FIG. 1) is operatively connected to the actuator 356. The controller 362 is configured to generate an adjustment signal based on received signals from various sensors of the snowmobile 10, described in detail below. The adjustment signal causes actuation of the actuator 356. This actuation drives the adjustment mechanism 302 to move the ski runner 106, ultimately adjusting the distance by which the ski runner 106 extends below the keel 142 of the ski 102 based on the adjustment signal.

In response to the adjustment signal from the controller 362, the motor 360 of the actuator 356 drives rotation of the screw 358, which is fixed to the shaft 318. This rotation causes the shaft 320 to move along the rotation axis 324, which, in turn, displaces the pin 372, as well as the runner connection axis 374, along an adjustment axis 376 (illustrated in FIG. 9) that runs parallel to the rotation axis 324. The displacement of the pin 372 results in the ski runner 106 moving along a translation axis 378 which is parallel to the walls 202, 204 of the ski runner body 200 and the walls 164, 168 of the ski body 140 defined by the slot 114.

As the ski runner 106 moves within the slot 114, along the translation axis 378, it remains rotationally fixed relative to the ski 102. It is noted that there may be a small amount of rotation of the ski runner 106 relative to the ski 102 due to the clearance between the ski runner 106 and the ski 102 required to permit translation of the ski runner 106, but the ski runner 106 is nonetheless considered to be rotationally fixed relative to the ski 102 for purposes of the present application.

With reference to FIG. 9, when the snowmobile 10 is on flat, level ground, the translation axis 378 is vertical and perpendicular to the ground engaging edge 206 of the ski runner body 200. It is noted that, in some embodiments, the translation axis 378 may not be perpendicular to the ground engaging edge 206 of the ski body 200. Additionally, when the snowmobile 10 is on flat, level ground, the ski leg pivot axis 134, the adjustment axis 376, and the rotation axis 324 are angled relative to the translation axis 378. However, it is contemplated that the runner adjustment assembly 108 could be modified so that the adjustment axis 376 and the rotation axis 324 are parallel to the translation axis 378.

With reference to FIG. 13, when the motor 360 rotates in a first direction, the pin 372 moves upwards along the adjustment axis 376. This upward movement causes the ski runner 106 to move upward along the translation axis 378, decreasing the distance by which the ski runner 106 extends below the keel 142. Conversely, with reference to FIG. 14, when the motor 360 rotates in the opposite direction, the pin 372 moves downward along the adjustment axis 376. This causes the ski runner 106 to move downward along the translation axis 378, thereby increasing the distance that the ski runner extends below the keel 142.

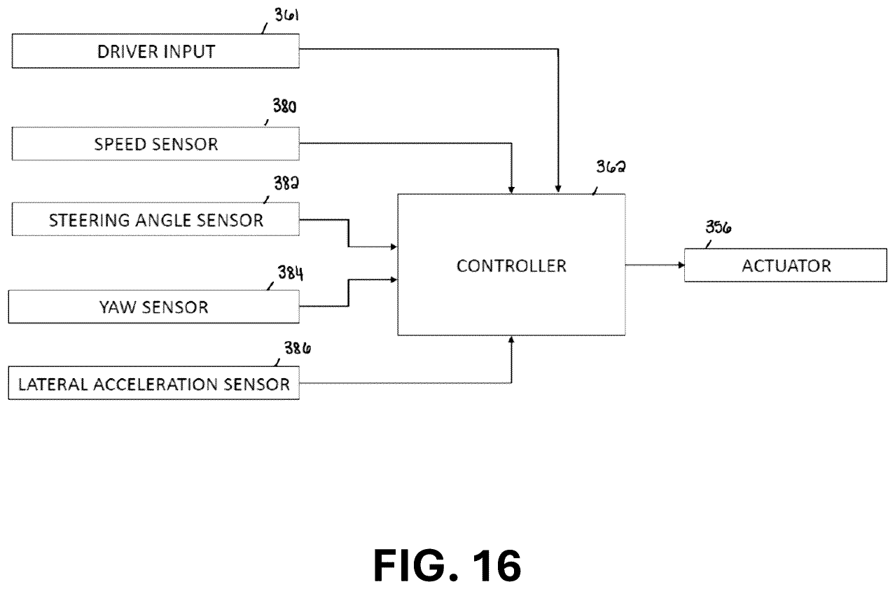

Referring to FIG. 16, in the present embodiment, the snowmobile 10 includes a speed sensor 380, which measures the speed of the snowmobile 10, and a steering angle sensor 382, which measures the steering angle of the handlebar 58. Each of the speed sensor 380 and the steering angle sensor 382 are in communication with the controller 362. In the present embodiment, the snowmobile 10 is further equipped with additional sensors in communication with the controller 362. Specifically, a yaw sensor 384 which measures a yaw of the snowmobile 10, and a lateral acceleration sensor 386, such as an accelerometer or an inertial measurement unit, which measures a lateral acceleration of the snowmobile 10. It is contemplated that in some embodiments, one or more of the sensors 380, 382, 384, 386 could be omitted.

The controller 362 is configured to receive signals from each of the respective sensors 380, 382, 384, 386. That is, the controller 362 receives a speed signal indicative of the sensed speed from the speed sensor 380, a steering angle signal indicative of the sensed steering angle from the steering angle sensor 382, a yaw signal indicative of the sensed yaw from the yaw sensor 384, and a lateral acceleration signal indicative of the sensed lateral acceleration from the lateral acceleration sensor 386.

The controller 362 is further configured to generate an adjustment signal based on at least the speed signal and the steering angle signal. The adjustment signal may be generated based on stored data within a memory storage 363 (shown schematically in FIG. 1). The controller 362 is communicatively connected to the memory storage 363. In the present embodiment, the stored data is a predetermined look-up table, as will be described in detail below. However, the stored data may vary in other embodiments. In the present embodiment, the adjustment signal may be further based on the yaw signal and/or the lateral acceleration signal, described in detail below. It is contemplated that in some embodiments, the adjustment signal may be based on only one of the steering angle signal, the speed signal, the yaw signal, or the lateral acceleration signal.

As described above, in response to the adjustment signal, the actuator 356 is actuated, to move the ski runner 106, adjusting the distance the ski runner 106 extends from the keel 142 of the ski 102. As a result, the extension of the ski runner 106 may be adjusted to accommodate for various conditions of the snowmobile 10, thereby improving the handling and performance of the snowmobile 10 and providing a better driving experience. For example, during cornering, the adjustment signal is based on at least one of the steering angle signal, the speed signal, and the yaw signal, which may cause the actuator 356 to move the ski runner 106 such that the distance by which the ski runner 106 extends from the keel 142 increases. This may provide improved grip and control, enabling the snowmobile 10 to maintain stability and reduce the risk of understeering during turns. In another example, to mitigate likelihood of darting, the adjustment signal is based on at least one of the steering angle signal, the speed signal, and the lateral acceleration signal, which may cause the actuator 356 to move the ski runner 106 such that the distance by which the ski runner 106 extends from the keel 142 decreases. This may reduce the likelihood of the skis 102 being pulled into pre-existing grooves, allowing for a more comfortable and stable ride for the driver, by reducing the constant effort which needs to be sustained to maintain the handlebars 58 straight, when experiencing this condition.

With continued reference to FIG. 16, the snowmobile 10 further includes a driver input 361, such as buttons, switches, or a touch screen. In the present embodiment, the driver input 361 activates the automatic adjustment of the ski runners 106, which is described in detail below.

In some embodiments, the driver input 361 may be configured to manually select the distance by which the ski runner 106 extends from the keel 142. For instance, the driver input 361 may be an input of a specific ski runner distance, or a preset ski runner distance setting, or a mode setting (such as “darting reduction setting”). The driver input 361 may generate a driver input signal to be received by the controller. In response, the controller 362 may be configured to generate an adjustment signal based on the driver input signal, and the actuator 356 actuates to move the ski runner 106, adjusting the distance the ski runner 106 extends from the keel 142 of the ski 102, as described above. A manually selected distance by which the ski runner 106 extends would override the automatic adjustment. It is contemplated that, in alternative embodiments, the driver input 361 may be omitted.

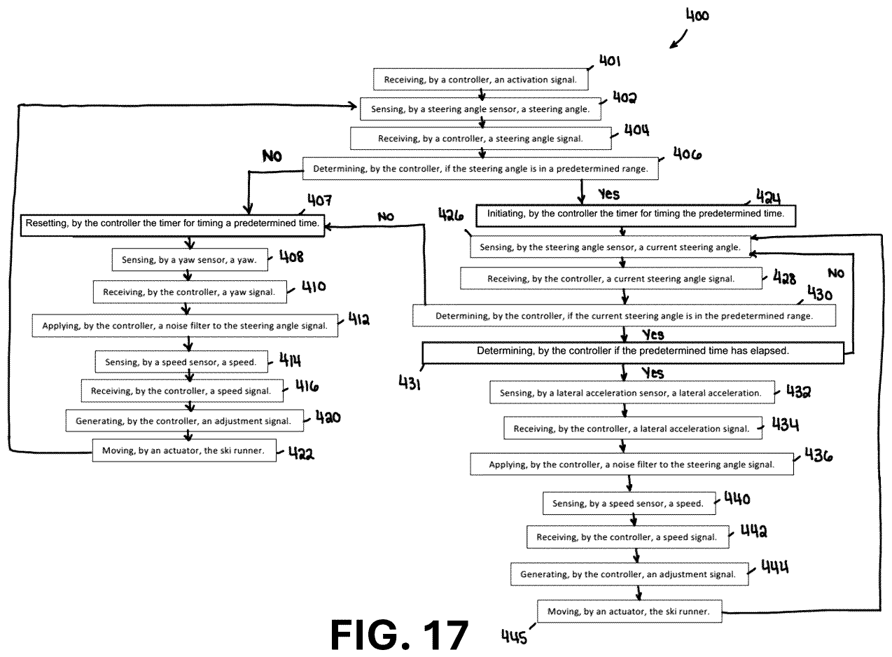

With reference to FIG. 17, a method 400 for adjusting the ski runner 106 of the snowmobile 10 will now be described in detail. In the present embodiment, the method 400 is described in the context of the snowmobile 10 undergoing cornering or experiencing darting. However, the method 400 may be applied to accommodate for different driving conditions and scenarios in other embodiments. Broadly, the method 400 involves the controller 362 generating the adjustment signal in response to at least one of the steering angle signal, the speed signal, the yaw signal (during cornering), and the lateral acceleration signal (during darting). In response to the adjustment signal the actuator 356 actuates, moving the ski runner 106 to adjust the distance of extension from the keel 142. This allows the ski runner 106 to be automatically adjusted, fine-tuning the amount the ski runner 106 extends from the keel 142 to improve drivability during cornering and/or reduce likelihood of darting. It is noted that the order of the steps of the method 400 is shown as an example, and therefore the steps of the method 400 may vary in other embodiments.

In the present embodiment, the method 400 begins, at step 401, with the controller 362 receiving an activation signal to begin performing the method 400. As mentioned above, the activation signal may be generated in response to the driver input 361 to activate the automatic adjustment of the ski runners 106. In alternative embodiments, the step 401 may be omitted and the method 400 may be initiated when the snowmobile 10 is turned on.

The method 400 continues, at step 402, with sensing, by the steering angle sensor 382, the steering angle of the handlebars 58. As described above, the steering angle sensor 382 is in communication with the controller 362 such that the steering angle signal is sent to the controller 362 from the steering angle sensor 382.

The method 400 continues, at step 404, with the controller 362 receiving the steering angle signal from the steering angle sensor 382. The steering angle signal is indicative of the steering angle.

At step 406, the method 400 continues with the controller 362 determining if the snowmobile 10 is in the process of turning, and therefore may be undergoing cornering. Specifically, the controller 362 determines whether the steering angle is within a predetermined angle range. In the present embodiment, the predetermined angle range is approximately +7.5° to −7.5°, where a steering angle within this range indicates the snowmobile 10 driving in a generally straight path (i.e., not turning). Conversely, a steering angle outside of this range indicates the snowmobile 10 is turning either left or right. It is contemplated that the predetermined angle range may vary in various embodiments.

If, at step 406, the steering angle is determined to be outside of the predetermined range, then the snowmobile 10 is turning or cornering, and the method proceeds to step 407.

At step 407, with the controller 362 resetting a timer. The timer is used for timing a predetermined time that is initiated at step 424, which will be described below.

The method 400 continues, at step 408, with sensing, by the yaw sensor 384, the yaw of the snowmobile 10. As described above, the yaw sensor 384 is in communication with the controller 362 such that the yaw signal is sent to the controller 362 from the yaw sensor 384.

The method 400 continues, at step 410, with the controller 362 receiving the yaw signal from the yaw sensor 384. The yaw signal being indicative of the sensed yaw of the snowmobile 10. In the present embodiment, the yaw signal acts as a multiplier applied to the steering angle signal, referred to hereinafter as “the yaw adjusted steering angle signal”. It is contemplated that, in alternative embodiments, the yaw sensor 384 may be omitted, and therefore steps 408 and 410 may be omitted.

The method 400 proceeds, at step 412, with the controller 362 applying a low-pass filter to the yaw adjusted steering angle signal, referred to hereinafter as “the filtered steering angle signal”. It is contemplated that a different filter may be applied to the steering angle signal. Alternatively, the step 412 may be omitted.

At step 414, the method 400 continues with sensing, by the speed sensor 380, the speed of the snowmobile 10. As described above, the speed sensor 380 is in communication with the controller 362 such that the speed signal is sent to the controller 362 from the speed sensor 380.

The method 400 continues, at step 416, with the controller 362 receiving the speed signal from the speed sensor 380. The speed signal is indicative of the speed of the snowmobile 10. It is contemplated that, in alternative embodiments, the speed sensor 380 may be omitted, and therefore steps 414 and 416 may be omitted.

The method 400 then proceeds, at step 420, with the controller 362 generating the adjustment signal based on the filtered steering angle signal, which incorporates the yaw signal as a factor of the steering angle signal, and the speed signal. It is contemplated that, in alternative embodiments, the yaw signal may be omitted, and thus the adjustment signal may be based only on the filtered steering angle signal and the speed signal. Similarly, in alternative embodiments, the speed signal may be omitted, and thus the adjustment signal may be based on the filtered steering angle, which incorporates the yaw signal. In even further alternative embodiments, the adjustment signal may solely be based on the filtered steering angle.

In the present embodiment, step 420 involves the controller 362 referencing stored data within the memory storage 363 of the snowmobile 10. In the present embodiment, the stored data is a predetermined look-up table which provides a distance value in which the ski runner 106 should extend from the keel 142 for a given steering angle value and a given speed value. As described above, the yaw signal has been incorporated into the steering angle signal. However, in alternative embodiments, the yaw signal may remain independent, and the predetermined look-up table may instead provide a distance value for a given steering angle value, a given yaw value, and a given speed value. It is contemplated that, in alternative embodiments where the yaw signal and/or the speed signal are omitted, the predetermined look-up table may instead provide a distance value for any given steering angle value.

From step 420, the method 400 proceeds, at step 422, with moving the ski runner 106 relative to the ski 102 based on the adjustment signal generated at step 420 by actuation of the actuator 365, thereby adjusting the distance by which the ski runner 106 extends below the keel 142, optimizing the performance of the snowmobile 10 to adapt to turning and potential cornering conditions.

In the present embodiment, as the steering angle increases (indicating a sharper turn to the left or right), the distance by which the ski runner 106 extends increases. Conversely, as the steering angle decreases, the distance by which the ski runner 106 extends decreases. In other words, for a constant speed, a larger steering angle results in greater extension, while a smaller steering angle results in less extension. Similarly, as the speed increases, the distance by which the ski runner 106 extends increases. Conversely, as the speed decreases, the distance by which the ski runner 106 extends decreases. In other words, for a constant steering angle, higher speeds result in greater extension, while lower speeds result in less extension. It is noted that this may vary in other embodiments, depending on other factors, for instance, on the calibration of the snowmobile 10 and/or other environmental factors.

From step 422, the method 400 is performed again, starting at step 402. In this embodiment, the method 400 is continued until receiving a deactivation signal in response to a driver input to deactivate the automatic adjustment of the ski runners 106. It is contemplated that, in alternative embodiments the method 400 may continue, beginning at step 402, until the snowmobile 10 is turned off.

If, at step 406, the steering angle is determined to be inside the predetermined range, indicating the snowmobile 10 is traveling a generally straight path (i.e., not significantly turning or cornering), the method 400 proceeds with determining whether the snowmobile 10 is traveling along the generally straight path for a prolonged period. Specifically, in the present embodiment, from 406, the method 400 continues at step 424, with the controller 362 initiating the timer for timing the predetermined time.

With the timer initiated, the method 400 continues, at step 426, with the steering angle sensor 382 sensing a current steering angle, referred hereinafter as “the current steering angle”, and at step 428, with the controller 362 receiving the current steering angle signal indicative of the current steering angle. It is noted that the current steering angle is the steering angle sensed by the steering angle sensor 382 at that specific point in time.

At step 430, the method 400 proceeds with the controller 362 determining if the current steering angle is within the predetermined angle range. In other words, the controller 362 determining if the snowmobile 10 is still traveling in the generally straight path.

If, at step 430, it is determined that the current steering angle is within the predetermined angle range (i.e., the snowmobile 10 is continuing to travel along the generally straight path), the method 400 continues, at step 431, with the controller 362 determining if the predetermined time has elapsed. In other words, at step 431, the controller 362 determines if the predetermined time has been reached or passed. In the present embodiment, the predetermined time is approximately 8 seconds, though this may vary in various embodiments.

If, at step 431, the predetermined time is not yet elapsed the method 400 repeats steps 426 to 431 until the predetermined time has been reached. While the method 400 has been described as continuously repeating steps 426 to 431 until the predetermined time elapsed, it should be noted that, in other embodiments, a specific sampling rate or a set number of steering angles may be sensed by the steering angle sensor 382.

If, at step 431, the predetermined time has elapsed and if the current steering angle is within the predetermined angle range, it indicates the snowmobile 10 has been traveling in the generally straight path for a prolonged period. As such, the method 400 can adjust the position of the ski runner 106 to reduce the likelihood of darting. The method 400 will continue with the last sensed steering angle (i.e., the current steering angle of step 426 when the time has elapsed).

The method 400 continues, at step 432, with sensing, by the lateral acceleration sensor 386, the lateral acceleration of the snowmobile 10. As described above, the lateral acceleration sensor 386 is in communication with the controller 362 such that the lateral acceleration signal is sent to the controller 362 from the lateral acceleration sensor 386.

The method 400 continues, at step 434, with the controller 362 receiving the lateral acceleration signal from the lateral acceleration sensor 386. The lateral acceleration signal being indicative of the sensed lateral acceleration of the snowmobile 10. In the present embodiment, the lateral acceleration signal acts as a multiplier applied to the steering angle signal (at step 434, the steering angle signal is indicative of the sensed steering angle at the end of the predetermined time) and is referred to hereinafter as “the lateral acceleration adjusted steering angle signal”. It is contemplated that, in alternative embodiments, the lateral acceleration sensor 386 may be omitted, and therefore steps 432 and 434 may be omitted.

From step 434, the method 400 proceeds, at step 436, with applying a low-pass filter to the lateral acceleration adjusted steering angle signal. It is noted that step 436 is substantially similar to step 412, and therefore will not be explained in further detail.

The method 400 continues with sensing, by the speed sensor 380, the speed of the snowmobile 10 and with the controller 362 receiving the speed signal from the speed sensor 380, at steps 440 and 442 respectively.

The method 400 then proceeds, at step 444, with the controller 362 generating the adjustment signal. Step 444 is substantially similar to step 420, but for the lateral acceleration signal being used instead of the yaw signal, and the last sensed steering angle (i.e., the sensed steering angle at the end of the predetermined time) being used. As such, step 444 will not be explained in further detail.

The method 400 continues, at step 445, with moving the ski runner 106 relative to the ski 102 based on the adjustment signal generated at step 444 by actuation of the actuator 356, thereby adjusting the distance by which the ski runner 106 extends below the keel 142, thereby optimizing the performance of the snowmobile 10 to adapt to cornering and potential darting conditions.

From step 445, the method 400 proceeds with repeating steps 426 to 445. It is noted that, in this embodiment, the timer is reset only when the current steering angle is outside of the predetermined angle range. As a result, when the method 400 returns to step 426 after step 445, the timer is already in an elapsed state (i.e., the time tracked by the timer will have already elapsed the predetermined time). Therefore, at step 431, the controller 362 will determine the predetermined time has elapsed and, if the current steering angle is within the predetermined angle range, the method 400 will proceed onto step 432.

If, at step 430, the current steering angle is outside of the predetermined angle range, indicating that the snowmobile 10 has started turning, the method 400 proceeds to step 407 where the timer is reset. Thus, in the present embodiment, the timer is reset when the steering angle is outside of the predetermined angle range. The method 400 then continues as described above.

If, at any time during the method 400, the controller 362 receives a deactivation signal in response to a driver input to deactivate the automatic adjustment of the ski runners 106, the method 400 is stopped. It is contemplated that, in alternative embodiments the method 400 may continue until the snowmobile 10 is turned off.

It is noted that, in the present embodiment, the method 400 begins with the timer in the elapsed state. In other words, at step 401, the timer is automatically set to the predetermined time such that the method 400 is primed to adjust the ski runner 106 to reduce likelihood of darting. It is contemplated that, in alternative embodiments, at step 401, the timer may begin in a reset state (i.e., the time is set to zero seconds).

As can be appreciated from the description above with regards to the method 400, in the present embodiment, the controller 362 will generate the adjustment signal, and thus cause the actuator 356 to move the ski runner 106, in instances when (i) the steering angle is outside of the predetermined angle range or (ii) the steering angle is inside the predetermined angle range and the predetermined time has elapsed.

In the present embodiment, the method 400 may be adapted to automatically retract the ski runner 106 when the snowmobile 10 is traveling along a hard surface to prevent wear and damage to the ski runner 106. Specifically, the method 400 may include receiving a hard surface signal, indicative that the snowmobile 10 is traveling along a hard surface. In some embodiments, the hard surface signal may be generated in response to the driver pressing the driver input 361 to retract the ski runner 106. In response to the hard surface signal the actuator 356 actuates the ski runners 106 to move to a retracted position. It is contemplated that, in alternative embodiments, this may be omitted.

It is noted that the method 400 has been described with reference to the snowmobile 10 having a left and right ski assembly 100. The method 400 may, in some instances, adjust each of the left and right ski assemblies 100 synchronously, such that each ski runner 106 is moved to extend the same distance. However, the method 400 may, in some instances, adjust each of the left and right ski assemblies 100 asynchronously, such that each ski runner 106 may be moved independently from one another. It is further contemplated that the method 400 may be applicable to snowmobiles 10 having a single ski assembly 100.

It is noted that, in some embodiments, a threshold may be applied to minimize continuous movement of the ski runner 106. For instance, the distance of the ski runner 106 relative to the ski 102 may remain unchanged unless the steering angle changes by a specific steering increment, such as an increase or decrease of 2°. In alternative embodiments, this may be omitted, and thus the distance of the ski runner 106 may be continuously adjusted.

It is contemplated that the method 400 may have additional steps, or that steps may be omitted. For example, it is contemplated that the adjustment of the ski runners 106 could be based only on the steering angle. In such an example, steps 408, 410, 418, 420, 432, 434, 440, and 442 would be omitted from the method 400.

Modifications and improvements to the above-described embodiments of the present technology may become apparent to those skilled in the art. The foregoing description is intended to be exemplary rather than limiting.

What is claimed is:

1. A method for adjusting a ski runner of a ski of a snowmobile, the method comprising:
sensing, by a steering angle sensor, a steering angle;
receiving, by a controller, a steering angle signal from the steering angle sensor, the steering angle signal being indicative of the sensed steering angle;
generating, by the controller, an adjustment signal based on the steering angle signal; and
moving the ski runner relative to the ski to adjust a distance by which the ski runner extends below the ski, the ski runner being moved by an actuator operatively connected to the ski runner, the actuator being actuated in response to the adjustment signal.

2. The method of claim 1, wherein:
the steering angle signal is a first steering angle signal indicative of a first sensed steering angle; and
the method further comprises:
determining, by the controller, if the first sensed steering angle is inside a predetermined angle range;
in response to the first sensed steering angle being inside the predetermined angle range:
initiating, by the controller, a timer for timing a predetermined time;
sensing, by the steering angle sensor, a second steering angle;
receiving, by the controller, a second steering angle signal from the steering angle sensor, the second steering angle signal being indicative of the second sensed steering angle;
determining, by the controller, if the second sense steering angle is inside the predetermined angle range;
in response to the second steering angle signal being inside the predetermined angle range, determining, by the controller, if the predetermined time has elapsed; and
in response to the predetermined time having elapsed, moving the ski runner relative to the ski to adjust the distance by which the ski runner extends below the ski using the actuator, the adjustment signal being based on the second steering angle signal.

3. The method of claim 2, wherein:
in response to at least one of the first steering angle and the second steering angle being outside the predetermined angle range, resetting the timer.

4. The method of claim 2, wherein the predetermined angle range is between approximately −7.5° and 7.5°.

5. The method of claim 2, wherein the predetermined time is approximately 8 seconds.

6. The method of claim 1, wherein generating the adjustment signal by the controller comprises referencing stored data within a memory storage of the snowmobile, the stored data providing distance values for given steering angle values.

7. The method of claim 1, further comprising:
sensing, by a speed sensor, a speed of the snowmobile; and
receiving, by the controller, a speed signal from the speed sensor, the speed signal being indicative of the sensed speed of the snowmobile.

8. The method of claim 7, wherein generating the adjustment signal by the controller comprises referencing a predetermined look-up table providing distance values for given steering angle values and speed values.

9. The method of claim 1, further comprising:
sensing, by a yaw sensor, a yaw of the snowmobile;
receiving, by the controller, a yaw signal indicative of the sensed yaw of the snowmobile; and
wherein the adjustment signal is further based on the yaw signal.

10. The method of claim 1, further comprising:
sensing, by a lateral acceleration sensor, the lateral acceleration of the snowmobile;
receiving, by the controller, a lateral acceleration signal indicative of the sensed lateral acceleration of the snowmobile; and
wherein the adjustment signal is further based on the lateral acceleration signal.

11. The method of claim 10, wherein the lateral acceleration sensor is an accelerometer.

12. The method of claim 1, further comprising:
receiving, by the controller, a hard surface signal; and
in response to receiving the hard surface signal, retracting the ski runner with the actuator.

13. The method of claim 12, further comprising receiving a user input generating the hard surface signal.

14. The method of claim 1, further comprising:
receiving, by the controller, an activation signal; and
performing the method in response to receiving the activation signal.

15. The method of claim 1, further comprising:
selecting a ski runner distance;
receiving, by the controller, a ski runner distance signal indicative of the selected ski runner distance; and
in response to receiving the ski runner distance signal, moving the ski runner relative to the ski to adjust the distance by which the ski runner extends below the ski using the actuator, the adjustment signal being based on the ski runner distance signal.

16. A snowmobile ski assembly for a snowmobile, the snowmobile ski assembly comprising:
a ski defining a slot;
a ski runner disposed in the slot, the ski runner being moveable in the slot relative to the ski; and
a runner adjustment assembly connected to the ski runner, the runner adjustment assembly having a motor operatively connected to the ski runner moving the ski runner relative to the ski,
the ski runner remaining substantially rotationally fixed relative to the ski during movement of the ski runner.

17. The snowmobile ski assembly of claim 16, further comprising:
a controller operatively connected to the motor of the runner adjustment assembly, the controller being configured to:
receive a steering angle signal indicative of a steering angle; and
send an adjustment signal to the motor to move the ski runner relative to the ski to adjust a distance by which the ski runner extends below the ski, the adjustment signal being based on the steering angle signal.

18. The snowmobile ski assembly of claim 17, wherein:
the controller is further configured to receive a speed signal indicative of a speed of the snowmobile; and
the adjustment signal is further based on the speed signal.

19. The snowmobile ski assembly of claim 17, wherein:
the controller is further configured to:
receive a user input; and
send an adjustment signal to the motor to move the ski runner relative to the ski to adjust a distance by which the ski runner extends below the ski, the adjustment signal being based on the user input.

20. The snowmobile ski assembly of claim 16, wherein the runner adjustment assembly is a linear actuator comprising the motor.
